(19) United States
(12) Patent Application Publication
(10) Pub. No.: US 2014/0216403 A1
(43) Pub. Date: Aug. 7, 2014

(54) GAS FUEL SYSTEM

(71) Applicant: CATERPILLAR INC., Peoria, IL (US)

(72) Inventor: Alan R. Stockner, Metamora, IL (US)

(73) Assignee: Caterpillar Inc., Peoria, IL (US)

(21) Appl. No.: 13/761,198

(22) Filed: Feb. 7, 2013

(51) Int. Cl. F02M 69/08; F17C 7/04

(52) U.S. Cl. CPC F02M 69/08; F17C 7/04
USPC 123/445; 62/50.2

(57) ABSTRACT

A gas fuel system for an engine is disclosed. The gas fuel system includes a fuel tank configured to supply cryogenic fuel. A cryogenic pump is configured to pressurize the cryogenic fuel received from the fuel tank. A heat exchanger is configured to receive the pressurized cryogenic fuel and an engine coolant. Further, the engine coolant flows through the heat exchanger to vaporize the pressurized cryogenic fluid. The gas system further includes a controller configured to receive a signal indicative of temperature of the engine coolant. Further, the controller sends a signal to impose one or more parasitic loads on the engine based on the temperature of the engine coolant.

### TECHNICAL FIELD

This present disclosure relates generally to a gas fuel system and, more particularly, to an engine coolant in the gas fuel system.

### BACKGROUND

Heavy machines like locomotives or large mining trucks may run on different types of engines that use more than one fuel. The engine may be a direct injection gas (DIG) engine or duel fuel engine system, in which a gaseous fuel, such as compressed natural gas, is injected into a cylinder at high pressure while combustion in the cylinder from a diesel pilot is already underway. In DIG engines, the gaseous fuel is stored in a liquid state at a low pressure, such as atmospheric pressure, and at low, cryogenic temperatures in a liquid storage tank. When exiting the liquid storage tank, the liquefied gaseous fuel requires heating to ultimately vaporize and reach a gaseous state prior to providing such gaseous fuel to the engine cylinders.

The heat required to vaporize the liquefied gaseous fuel may be provided to a stream of liquefied gaseous fuel passing through a heat exchanger or heater by using warm coolant from the engine. However, when the engine is operating in cold environments, the engine coolant may not have sufficient heat to vaporize the liquefied gaseous fuel at a rate that is sufficient to operate the engine at a desired power output. Further, the engine coolant may require warming during the cold-start engine conditions, so that heat from the coolant may serve to obtain full engine power by vaporization of the liquefied gaseous fuel. The engine coolant may be warmed by using auxiliary means such as, but not limited to, heaters or by using engine waste heat. However, the use of the auxiliary means may be an incremental heating process. Further, inclusion of the auxiliary means may increase complication and cost of the engine system.

G. B. Patent number 2,088,475 discloses a liquid-gas supply apparatus for an internal combustion engine. The apparatus comprises a means for supplying a liquid gas from a pressure reservoir to a vaporiser/regulator device, connected to a coolant circuit of an engine to provide a flow of coolant through the device. Further, the vaporiser/regulator device include an electrical heating element, for example, a rapid heating glow plug disposed in the coolant flow path and operates in dependence upon temperature and/or time, during and shortly after cold-starting of the engine. However, there remains areas for improvement in the art.

### SUMMARY

In one embodiment of the present disclosure, a gas fuel system for an engine is disclosed. The gas fuel system includes a fuel tank configured to supply cryogenic fuel. A cryogenic pump is configured to pressurize the cryogenic fuel received from the fuel tank. A heat exchanger is configured to receive the pressurized cryogenic fuel and an engine coolant. Further, the engine coolant flows through the heat exchanger to vaporize the pressurized cryogenic fluid. The gas system further includes a controller configured to receive a signal indicative of temperature of the engine coolant. Further, the controller sends a signal to impose one or more parasitic loads on the engine based on the temperature of the engine coolant.

In another embodiment of the present disclosure, a method of warming the engine coolant is disclosed. The method includes pressuring cryogenic fluid in a cryogenic pump. Further, the method includes supplying the pressurized cryogenic fluid to the heat exchanger, and supplying the engine coolant to the heat exchanger to vaporize the cryogenic fluid. The method also includes sensing the temperature of the coolant, and imposing one or more parasitic loads on the engine based on the coolant temperature.

Other features and embodiments of this disclosure will be apparent from the following description and the accompanying drawings.

### BRIEF DESCRIPTION OF THE DRAWINGS

FIG. 1 is a side view of a machine in accordance with an embodiment of the present disclosure;

FIG. 2 is a block diagram of a an engine system in accordance with an embodiment of the present disclosure; and

FIG. 3 illustrates a warm-up strategy for an engine coolant in accordance with the present disclosure.

### DETAILED DESCRIPTION

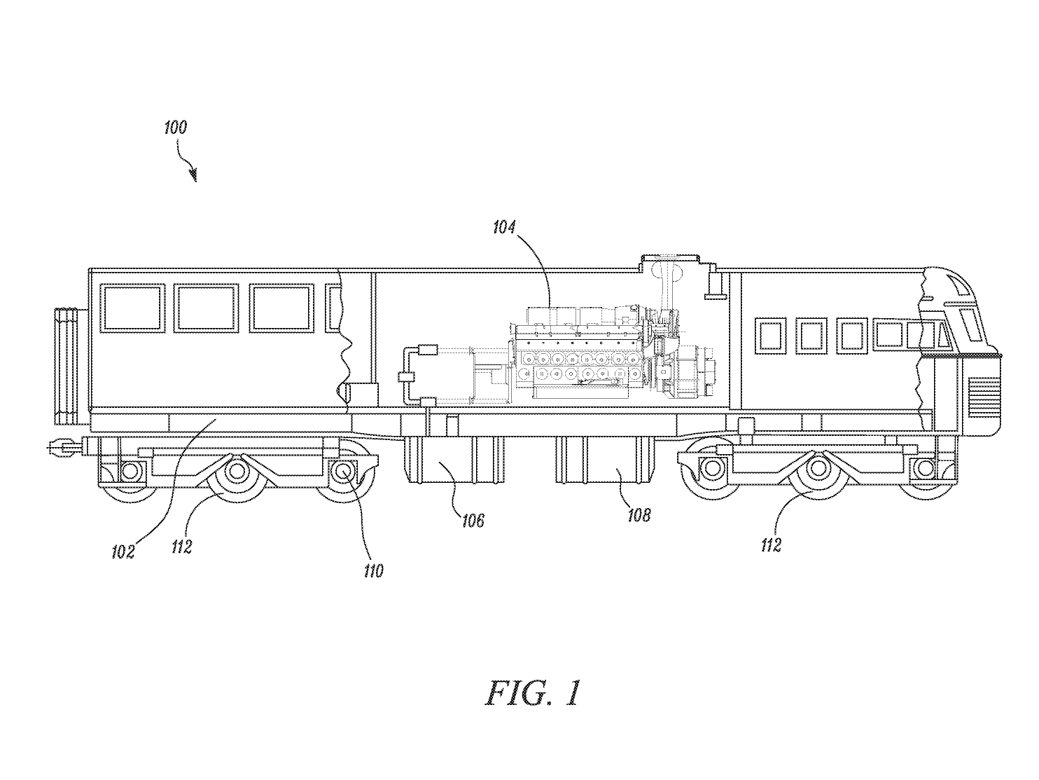

FIG. 1 illustrates a side view of a machine 100, such as a locomotive, in which various embodiments of the present disclosure may be implemented. The machine 100 includes a frame 102. The frame 102 may support an engine 104, a first fuel tank 106 and a second fuel tank 108. Further, the frame 102 may be disposed on one or more axles 110, associated with a plurality of wheels 112. In the illustrated embodiment, the frame 102 may further support various parts such as, power trains, hydraulic pumps, motors, valves, hydraulic lines, heat exchangers, and control systems. The engine 104 may be of any type, for example, but not limited to, an internal combustion engine, a gas turbine engine, or combinations thereof. In an aspect of the present disclosure, the engine 104 may be a direct injection gas engine 104, which may utilize more than one fuel. The engine 104 may be used in applications such as, but not limited to, large mining trucks, electric trucks, and the like.

The first fuel tank 106 and the second fuel tank 108 may be made of, for example, a steel body of a standard size ISO tank. The first fuel tank 106 and the second fuel tank 108 may further include plurality of openings and access points for removably connecting various hoses, control valves, etc. Further, the first fuel tank 106 and the second fuel tank 108 may be configured to hold fuel such as, for example, liquefied natural gas (“LNG”), compressed natural gas (“CNG”), gasoline, diesel and their equivalents. The first fuel tank 106 and the second fuel tank 108 are each configured to supply the fuel to the engine 104 via a plurality of lines. The first fuel tank 106 and the second fuel tank 108 may include one or more filters and pumps. The filters may remove any impurities such as dirt or dust particles present in the fuel while the pumps may suck, pressurize, and deliver the fuel to injectors of the engine 104.

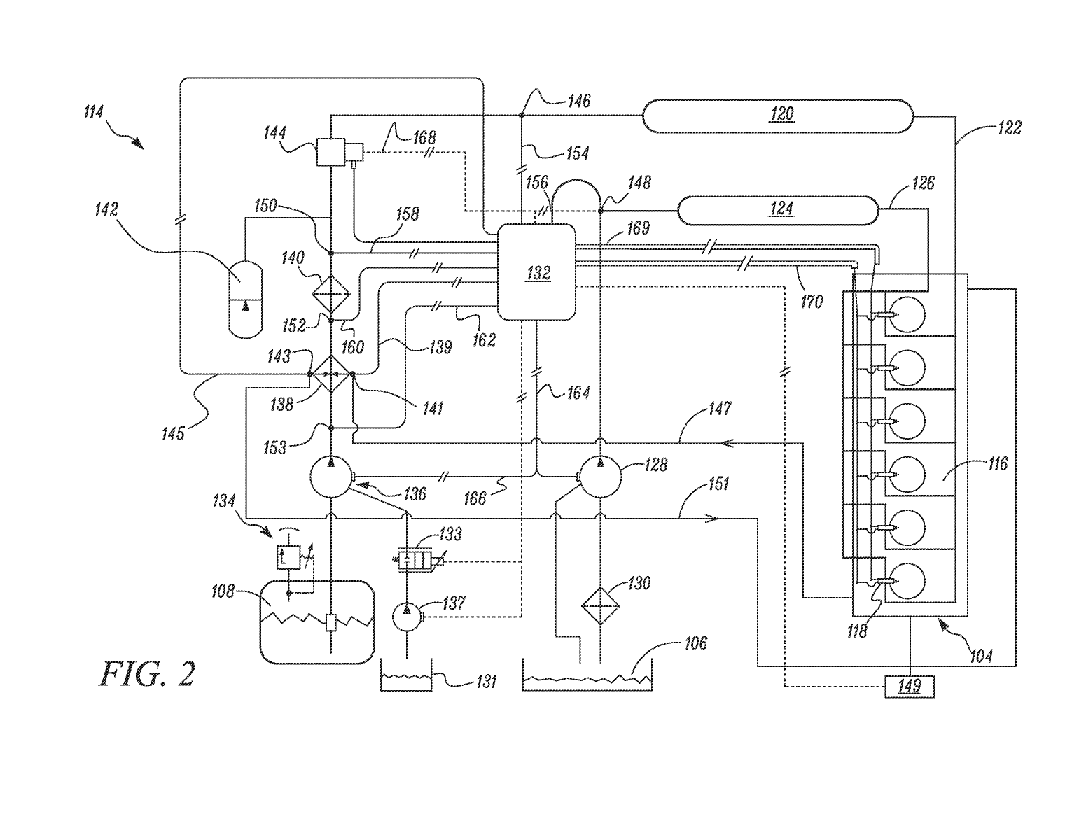

FIG. 2 illustrates a block diagram of an engine system 114 including the engine 104 of FIG. 1, which includes a gas fuel system and a liquid fuel system, in accordance with the present disclosure. The engine 104 may include one or more cylinders 116. Further, one or more engine cylinders 116 may be associated with fuel injectors 118. The fuel injector 118 may be a dual-check injector configured to independently inject predetermined amounts of two separate fuels. Although, a single fuel injector 118 is configured to independently inject two separate fuels, it is contemplated that two injectors, one corresponding to each of the two fuels, may be used. The fuel injector 118 may be connected to a gas fuel rail 120 via a high-pressure gas fuel supply line 122. Further, the fuel injector 118 may be connected to a high-pressure liquid fuel rail 124 via a liquid fuel supply line 126.

In the illustrated embodiment, the gaseous fuel may be a cryogenic fuel, for example, or can be a natural or petroleum gas, which is maintained within the gas fuel rail 120 at a pressure of about 25-50 MPa. Further, the liquid fuel may be for example, a diesel fuel, which is maintained within the liquid fuel rail 124 of about 25-50 MPa. Additionally, the liquid fuel may be any hydrocarbon based fuel such as, for example, DME (Di-methyl Ether), biofuel, MDO (Marine Diesel Oil), or HFO (Heavy Fuel Oil). In an embodiment of the present disclosure, the gaseous fuel may be a liquefied natural gas (LNG) and the liquid fuel may be a diesel fuel. Further, the LNG and the diesel fuel may be kept at any pressures ranges, not limited to the above-mentioned ranges, based on the operating conditions of the engine system 114. Although the reference is made to the fuels present in the gas fuel rail 120 and the liquid fuel rail 124 using the words “gaseous” or “liquid,” these designations are not intended to limit the phase in which fuel is present in the respective rails, but are rather used solely for the sake of discussion. For example, the LNG which is converted to compressed natural gas is provided at a controlled pressure within the gas fuel rail 120. The physical characteristics of such pressurized gas in the gas rail 120 may depend on the pressure at which it is maintained, and may be in a liquid, gaseous or supercritical phase.

As illustrated in the FIG. 2, the diesel fuel is stored in the first fuel tank 106. The diesel fuel may be drawn into and pressurized in a hydraulic pump 128 through a filter 130 and at a variable rate depending on the operating conditions of the engine system 114. The hydraulic pump 128 may be configured to selectively increase the pressure of the diesel fuel to a pressure that can vary in response to a pressure command signal provided to the hydraulic pump 128 from a controller 132. The pressurized fuel from the hydraulic pump 128 is provided to the liquid fuel rail 124.

Further, the LNG may be stored in a liquid state in the second fuel tank 108. The LNG can be maintained at a relatively low pressure, for example, atmospheric, or at a higher pressure. In the illustrated embodiment, the second fuel tank 108 may be insulated to store the LNG at a temperature of about −160° C. (−256° F.) and a pressure of about 100-1750 kPa. Other storage conditions may be used. The second fuel tank 108 may further include a pressure relief valve 134. Further, the LNG may be compressed by a cryogenic pump 136 to a required pressure based on the operating conditions of the engine system 114. Further, the cryogenic pump 136 may be driven by an oil pump 137. A reservoir 131 is configured to supply oil to the oil pump 137. A pressure regulation valve 133 may be configured to selectively allow pressurized oil from the oil pump 137 to drive the cryogenic pump 136. The controller 132 may control the oil pump 137 based on the operating conditions of the engine system 114. Further, the oil pump 137 may be configured to selectively drive the cryogenic pump 136 based on a signal from the controller 132. The controller 132 may further control the pressure regulation valve 137 to selectively allow the pressurized oil from the oil pump 137 to drive the cryogenic pump 136. The cryogenic pump 136 may raise the pressure of the LNG, while maintaining the LNG in a liquid phase. The cryogenic pump 136 may be configured to selectively increase the pressure of the LNG to a pressure that can vary in response to a pressure command signal provided to the cryogenic pump 136 from the controller 132.

Further, the compressed LNG may be heated in a heat exchanger 138. The heat exchanger 138 may be any known type of heat exchanger or heater, which may be adapted for use with the LNG. In an embodiment of the present disclosure, the heat exchanger 138 is a jacket water heater that extracts heat from an engine coolant. Alternatively, the heat exchanger 138 may be an active heater, for example, a fuel fired heater or an electrical heater. The coolant may be supplied from the engine 104 via an inlet line 147. The coolant may also be sent to the engine 104 or the coolant pump (not shown) via an outlet line 151. The engine coolant and the cryogenic fuel may travel in a parallel flow or a counter flow in the heat exchanger 138. The heat exchanger 138 provides heat to the compressed LNG to reduce density and viscosity while increasing its enthalpy and temperature. The compressed LNG may enter the heat exchanger 138 in a cryogenic, liquid state, and exit the heat exchanger 138 in a supercritical gas state, which is used herein to describe a state in which the fuel is gaseous but has a density that is between that of its vapor and liquid phases. In one example, the compressed LNG may enter the heat exchanger 138 at a temperature of about −160° C., a density of about 430 kg/m³, an enthalpy of about 70 kJ/kg, and a viscosity of about 169 μPa s as a liquid, and exit the heat exchanger 138 at a temperature of about 50° C., a density of about 220 kg/m³, an enthalpy of about 760 kJ/kg, and a viscosity of about 28 μPa s. It should be appreciated that the values of such representative state parameters may be different depending on the particular composition of the fuel being used.

In an aspect of the present disclosure, the engine coolant supplied from the engine 104 may need to be sufficiently warm to heat the cryogenic LNG entered into the heat exchanger 138. During cold start of the engine 104, the engine coolant may need to be rapidly warmed up. The engine coolant may be warmed by using parasitic loads 149 such as, but not limited to, pumps, resistance heaters, exhaust braking, dynamic braking, engine idle warm-up, torque converter. Further, the controller 132 may sense a low engine coolant during cold start of the engine 104 and thus, invoke a warm-up strategy by turning on the parasitic loads 149 controlled by the controller 132.

In an embodiment, upon the cold start of the engine 104, the controller 132 may sense the inlet coolant temperature 139. Temperature sensors 141, 143 may be disposed on the heat exchanger 138 to sense the inlet coolant temperature 139 and the outlet coolant temperature 145, respectively. The controller 132 determines if the engine coolant temperature is lower than a predetermined temperature. In the event of a low engine coolant temperature, the controller 132 may impose the parasitic loads 149 on the engine 104. The parasitic loads 149 may include the engine 104 being operated in a high idle warm up mode. The high idle engine warm up mode may serve to increase friction and load of the engine 104. The increase in the friction and load of the engine 104 may increase the engine coolant temperature, which is then supplied to the heat exchanger 138.

In another embodiment, the controller 132 may impose the parasitic loads 149 on the engine 104 by commanding the oil pump 137 to a pressure relief mode, during the cold start or warm-up of the engine 104. The oil pump 137 may be set to a maximum system pressure, while operating the oil pump 137 in the pressure relief mode. This phenomenon may provide a significant load on the engine 104. The increase in the load of the engine 104 may warm up the engine coolant. In another embodiment, the engine system 114 may include various other hydraulic pumps associated with various operations of the machine 100 and may be operated in a similar mode.

In an embodiment of the present disclosure, the controller 132 may further impose the parasitic loads 149 on the machine 100 or the electric truck, an engine generator is loaded with a dynamic brake grid resistance. The heat generated during dynamic braking may be supplied to warm up the engine coolant. In an embodiment, the pressures of the gas fuel rail 120 and the liquid fuel rail 124 may be increased to the maximum pressures. The increase in the pressures of the gas fuel rail 120 and the liquid fuel rail pressure 124 may heat the fluids slightly due to their compression, as well as increasing the engine power to both the hydraulic pump 128 and the cryogenic pump 136. The cryogenic pump 136 stroking the LNG may be commanded to go to a full pressure relief, thereby increasing the load of the engine 104. Further, if the engine 104 is equipped with an exhaust brake, one or more of the engine cylinders 116 may be placed in a “exhaust brake mode” to increase the load of the engine 104.

In one example, if a drive of the engine 104 is equipped with a torque converter, the torque converter may be loaded with about 50% power and may run in direct mechanical drive from the engine 104. The torque converter loaded with approximately 50% power may increase the load of the engine 104, thereby warming up the engine coolant. In an embodiment, the engine driven power steering pumps or alternators may be switched across a resistance heater. The resistance heater may be located on the engine coolant inlet to the heat exchanger 138. This may provide additional engine power to directly heat the engine coolant.

As illustrated in FIG. 2, the LNG exiting the heat exchanger 138 may be screened at a gas filter 140. A portion of the filtered LNG may be stored in a pressurized accumulator 142, and the remaining gas is provided to a pressure control module 144. The pressure-regulated gas is provided to the gas fuel supply line 122. Further, the pressure control module 144 is responsive to a control signal from the controller 132 and/or is configured to regulate the pressure of the LNG provided to the fuel injector 118. The pressure control module 144 may be a mechanical device such as a dome-loaded regulator or can alternatively be an electromechanically controlled device, operated in responsive to a command signal from the controller 132.

The engine system 114 may include various other sensors that provide information to the controller 132 relative to the operating state and overall health of the engine system 114. The engine system 114 may include various sensors that are indicative of the state of the fuels at various locations in the system. Such sensors may include a gas state sensor 146, a liquid state sensor 148, a filter state sensor 150, a heater state sensor 152, and an additional state sensor 153. The sensors may send the corresponding signals to the controller 132.

Accordingly, the gas state sensor 146 is disposed to measure and provide a gas rail state signal 154 indicative of a fluid state at the gas fuel supply line 122. The gas rail state signal 154 may be indicative of pressure and/or temperature of the gas. Further, the liquid state sensor 148 is disposed to measure a liquid rail state signal 156 indicative of a fluid state at the liquid fuel supply line 126. The filter state sensor 150 is disposed to measure and provide a filter state signal 158 indicative of the gas state between (downstream of) the gas filter 140 and (upstream of) the pressure control module 144. The filter state signal 158 may be indicative of the gas pressure. Further, the heater state sensor 152 is disposed to measure and provide a heater state signal 160 indicative of the gas state between the heat exchanger 138 and the gas filter 140. The heater state signal 160 may be indicative of gas temperature at that location. An additional state sensor 153 is disposed to measure and provide a liquid state signal 162 at the outlet of the hydraulic pump 128. The liquid state signal 162 at the outlet of the hydraulic pump 128 may be indicative of gas pressure, and can serve as reference to diagnose the hydraulic pump operations. The liquid state signal 162 may also be indicative of the gas temperature, for purposes of comparing to the heater state signal 160 downstream of the heat exchanger 138 and for diagnosing the operating state of the heat exchanger 138. The gas rail state signal 154, the liquid rail state signal 156, the filter state signal 158, the heater state signal 160, the liquid state signal 162, and/or other state signals indicative of the fluid state for the liquid/gaseous fuel may be provided to the controller 132 continuously during operation of the engine system 114.

The controller 132 may include a memory, a secondary storage device, a clock, and one or more processors that cooperate to accomplish a task consistent with the present disclosure. Numerous commercially available microprocessors can be configured to perform the functions of the controller 132. It should be appreciated that the controller 132 could readily embody a general machine controller capable of controlling numerous other functions of the machine 100. Various known circuits may be associated with the controller 132, including signal-conditioning circuitry, communication circuitry, and other appropriate circuitry. It should also be appreciated that the controller 132 may include one or more of an application-specific integrated circuit (ASIC), a field-programmable gate array (FPGA), a computer system, and a logic circuit configured to allow the controller 132 to function in accordance with the present disclosure. Further, the controller 132 may be a part of the electronic control module.

In another embodiment, the controller 132 includes functionality and algorithms that operate to monitor the various signals provided by the system sensors, and detect various failure or abnormal operating modes of the engine system 114. This enables the controller 132 to generate signals so that mitigating actions can be taken to promote engine 104 warming after the cold engine start and/or steady engine operation in frigid conditions such as, for example, where ambient air temperature is at or below −20° C. In other words, the controller 132 may include a temperature control system for the engine system 114 that can detect and address temporary or permanent thermal energy-related issues in the fuel system, especially those issues that may arise during the cold engine start or engine operation at low ambient temperature conditions. In addition to cold engine starts and operations in frigid ambient air temperature conditions, other examples of abnormal operating conditions associated with thermal energy-related issues may include water ingress and freezing issues with various fuel system components; and conditions in which excess thermal energy is present such as when the system operates at high ambient air temperature conditions. Other examples of abnormal operating conditions include clogging of any of the filters, freezing and/or clogging of the heat exchanger 138, malfunction of the pressure control module 144, and/or other conditions that specifically relate to the supply of the compressed gas to and from gas fuel supply line 122.

The controller 132 may further provide signals controlling or setting the displacement of the hydraulic pump 128 and the cryogenic pump 136. More specifically, a hydraulic pump control signal 164 and a cryogenic pump control signal 166 are determined in the controller 132 and may be provided to the respective pumps to control the displacement and, thus, the amount of fuel each pump 128 and 136 provides during operation. Further, the controller 132 may set a desired rail pressure of the LNG through the pressure control module 144 through a signal command 168. In an embodiment, the controller 132 may send signals 169 and 170 to the fuel injectors 118 to selectively inject the predetermined amount of the diesel fuel and the LNG, respectively.

### INDUSTRIAL APPLICABILITY

The present disclosure is applicable to engines having a gaseous fuel system operating with a liquid fuel system, wherein the liquid fuel serves as a pilot fuel to ignite the gaseous fuel. Although the machine 100 is illustrated as locomotive in the present embodiment, the machine may be, but not limited to, large mining trucks or electric trucks. In extreme conditions, for example, a cold engine start or the engine operating in frigid environments, there may temporarily be no thermal energy available for heating the gaseous fuel because engine coolant temperature is low and may freeze enough to lead to freezing of the engine coolant within a heat exchanger. The controller may impose a warm-up strategy for the engine coolant. This functionality is accomplished both by software algorithms operating within the controller as well as by various hardware capabilities of the engine components and systems.

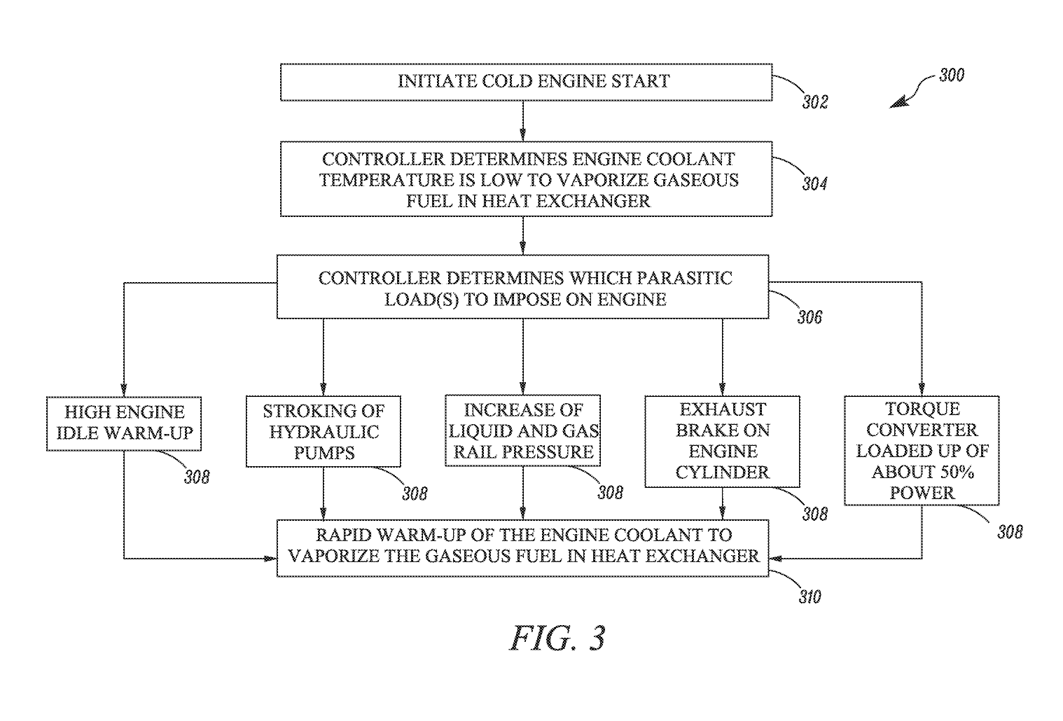

FIG. 3 illustrates in flowchart form, a warm-up strategy 300 for the engine coolant of the engine system 114 of FIG. 2. The warm-up strategy is initiated with a cold engine start, in operation 302. In operation 304, the controller 132 determines the engine coolant temperature is low to vaporize the gaseous fuel in the heat exchanger 138. In operation 306, the controller 132 determines which form of parasitic loads 149 to impose on the engine 104. In operation 308, at least one parasitic load 149 (as explained in FIG. 2) is selected. As an example, a high engine idle warm-up mode can be selected to provide heat to warm up the engine coolant. The controller 132 can also select to impose parasitic loads on the engine 114 by stroking various hydraulic pumps of the machine 100 to maximum pressures or by increasing the gas fuel rail pressures 120 and the liquid fuel rail pressures 124 of the engine system 114. The controller 132 can also impose parasitic loads 149 on the engine 114 by providing exhaust brakes on one or more of the engine cylinders 116; and/or by connecting the engine drive with a torque converter which may be loaded up to 50% power. These parasitic loads 149 on the engine 104 may rapidly warm the engine coolant, as shown at operation 310, without requiring an auxiliary heating means. The use of the parasitic loads 149 to warm-up the engine coolant may reduce the complication of the engine system 114. Further, the parasitic loads 149 may reduce cost of the overall system with rapid warm-up of the engine coolant.

In another embodiment, the controller 132 may receive signals indicative of the operating state of the engine system 114 for various sensors such as the temperature sensors 141, 143, the gas state sensor 146, the liquid state sensor 148, the filter state sensor 150, the heater state sensor 152, and the additional state sensor 153. These sensors may send the corresponding signals to the controller 132. Based on the signals from various sensors, the controller 132 may assess the operating health of those systems and address any thermal issues that may arise. More specifically, and in parallel reference to FIG. 2, the controller 132 may receive the inlet coolant temperature 139 and the outlet coolant temperature 145. Further, after sensing the low coolant temperature, the controller 132 may impose the parasitic loads 149 on the engine 104.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A gas fuel system for an engine comprising:
a fuel tank configured to supply cryogenic fuel;
a cryogenic pump configured to pressurize the cryogenic fuel received from the fuel tank;
a heat exchanger configured to receive the pressurized cryogenic fuel from the cryogenic pump, and an engine coolant such that the engine coolant flows through the heat exchanger to vaporize the pressurized cryogenic fluid; and
a controller configured to:
receive a signal indicative of a temperature of the engine coolant; and
send a signal to impose one or more parasitic loads on the engine based on the temperature of the engine coolant.

2. The gas fuel system of claim 1, wherein the cryogenic fuel is a liquid natural gas.

3. The gas fuel system of claim 1, wherein the cryogenic pump is driven by an oil pump.

4. The gas fuel system of claim 1, wherein the engine coolant and the cryogenic fuel travel in a parallel flow or a counter flow in the heat exchanger.

5. The gas fuel system of claim 1, wherein the vaporized cryogenic fuel is supplied to a pressure control module.

6. The gas fuel system of claim 5, wherein the pressurized control module selectively regulates pressure of the vaporized cryogenic fuel in responsive to a control signal from the controller.

7. The gas fuel system of claim 1, wherein a temperature sensor is disposed on the heat exchanger to sense the engine coolant temperature.

8. The gas fuel system of claim 1, wherein the parasitic loads is selected from a group consisting one or more of pumps, resistance heaters, exhaust braking, engine idle warm-up, fuel pressure, and torque converter.

9. A machine comprising:
an engine including one or more engine cylinders;
a liquid fuel system configured to supply pressurized liquid fuel into the engine cylinders;
a gas fuel system including:
a fuel tank configured to supply cryogenic fuel;
a cryogenic pump configured to pressurize the cryogenic fuel received from the fuel tank; a heat exchanger configured to receive the pressurized cryogenic fuel from the cryogenic pump, and an engine coolant such that the engine coolant flows through the heat exchanger to vaporize the pressurized cryogenic fluid; and
a controller configured to:
receive a signal indicative of a temperature of the engine coolant; and
send a signal to impose one or more parasitic loads on the engine based on the temperature of the engine coolant.

10. The machine of claim 9, wherein the liquid fuel is pressurized by a hydraulic pump.

11. The machine of claim 9, wherein the cryogenic fuel is a liquid natural gas.

12. The machine of claim 9, wherein the cryogenic pump is driven by an oil pump.

13. The machine of claim 9, wherein the engine coolant and the cryogenic fuel travel in a parallel flow or a counter flow in the heat exchanger.

14. The machine of claim 9, wherein the vaporized cryogenic fuel is supplied to a pressure control module.

15. The machine of claim 14, wherein the pressure control module selectively regulates the vaporized cryogenic fuel in responsive to a control signal from the controller.

16. The machine of claim 9, wherein the parasitic loads is selected from a group consisting of oil pump, resistance heaters, exhaust braking, engine idle warm-up, fuel pressure and torque converter.

17. The machine of claim 9, wherein the controller selectively sends signals to a fuel injector to direct at least one of the liquid fuel and the cryogenic fuel into the engine cylinders.

18. A method of warming an engine coolant during a cold engine start, the method comprising:
pressuring cryogenic fluid in a cryogenic pump;
supplying the pressurized cryogenic fluid to a heat exchanger;
supplying engine coolant to the heat exchanger to vaporize the cryogenic fluid;
sensing a temperature of the engine coolant temperature by a controller; and
imposing one or more parasitic loads on the engine by the controller based on the temperature of the engine coolant.

19. The method of claim 18 further includes regulating pressure of the vaporized cryogenic fuel by a pressure control module in responsive to a control signal from the controller.

20. The method of claim 18, imposing the parasitic loads is selected from a group consisting one or more of pumps, resistance heaters, exhaust braking, cylinder exhaust brake, engine idle warm-up, and torque converter.
